(19) United States
(12) Patent Application Publication
(10) Pub. No.: US 2026/0200350 A1
(43) Pub. Date: Jul. 16, 2026

(54) ONBOARD CHARGER WITH POWER STAGE INTEGRATION

(71) Applicant: VISTEON GLOBAL TECHNOLOGIES, INC., Van Buren Township, MI (US)

(72) Inventors: Kai Zhuang, Shanghai (CN); Tao Wang, Oakland Township, MI (US); Feng Wang, Shanghai (CN); Xunyan Yuan, Shanghai (CN); Zilai Zhao, Novi, MI (US)

(73) Assignee: VISTEON GLOBAL TECHNOLOGIES, INC., Van Buren Township, MI (US)

(21) Appl. No.: 19/136,277

(22) PCT Filed: Dec. 6, 2022
(86) PCT No.: PCT/CN2022/136933

§ 371 Date: Jun. 5, 2025

(51) Int. Cl. B60L 53/22; B60L 58/18; H02J 7/06; H02J 7/34; H02M 1/00; H02M 1/42; H02M 3/00; H02M 3/335

(52) U.S. Cl. CPC B60L 53/22; B60L 58/18; H02J 7/06; H02J 7/342; H02M 1/0067; H02M 1/4208; H02M 3/01; H02M 3/33573; H02M 3/33576; B60L 2210/10; H02J 2207/20

(57) ABSTRACT

An integrated power converter. The integrated power converter may include a first circuit configured to interface a first DC electrical power of power factor correction circuit with a first primary side of a first transformer, a second circuit arranged in an integrated formation and configured to interface a second DC electrical power at a first secondary side of the first transformer with a first battery and with a second primary side of a second transformer, and a third circuit configured to interface a third DC electrical power at a second secondary side of the of the second transformer with a second battery.

### INTRODUCTION

The present disclosure relates to onboard chargers, such as but not necessarily limited to chargers included onboard a vehicle to charge and/or discharge one or more vehicle batteries and/or battery packs.

A vehicle, such as but not necessarily limited to an electric vehicle or automobile, may include a high voltage battery pack configured to provide electrical power to a traction motor used to drive the vehicle and a low voltage battery pack to provide electrical power to vehicle systems operating at a lower voltage than the traction motor. It may be advantageous in some circumstance to charge the high and low voltage battery packs using electrical power provided from an alternating current (AC) charging station offboard the vehicle, such as the AC electrical power provided from the charging station to an onboard charger of the vehicle. As one skilled in the art will appreciate, such onboard chargers have historically relied upon separately housed and/or independent or dedicated circuits to respectively charge the high and low voltage battery packs.

### SUMMARY

One aspect of the present disclosure contemplates an onboard charger with power stage integration of circuitry used to charge high and low voltage battery packs of a vehicle. The power station integration may include arranging circuit components in an integrated or shared formation whereby a portion of the circuit components may be employed to charge both of the high and low voltage battery packs, as opposed to being dedicated to charging no more than one of the high and low voltage battery packs. These integrated or shared circuit components may reduce or otherwise limit the quantity of circuit components included as part of the onboard charger, which may in turn be beneficial in limiting vehicle weight, size, complexity, costs, etc.

One non-limiting aspect of the present disclosure relates to an integrated power converter. The integrated power converter may include a first circuit including a plurality of first transistors configured to interface a first DC electrical power of power factor correction circuit with a first primary side of a first transformer, a second circuit including a plurality of second transistors arranged in an integrated formation and configured to interface a second DC electrical power at a first secondary side of the first transformer with a first battery and with a second primary side of a second transformer, and a third circuit including a plurality of third transistors configured to interface a third DC electrical power at a second secondary side of the of the second transformer with a second battery.

The second transistors may be comprised of no more than six transistors.

The second transistors may be comprised of at least six transistors, with the integrated formation corresponding with pairs of the six transistors connected source to drain and each pair thereof connected in parallel.

The first transistors may be comprised of four transistors, with pairs of the four transistors connected source to drain and each pair thereof connected in parallel.

The third transistors may be comprised of two transistors connected source to drain.

The third circuit may include a capacitor configured to smooth the third DC electrical power or alternatively include a capacitor and an inductor configured to smooth the third DC electrical power.

The integrated power converter may include a controller configured to selectively control the first, second, and third transistors to implement a first battery charging mode, a combined first and second battery charging mode, and a first battery to second battery charging mode.

The first battery charging mode may include converting the first DC electrical power from the power factor correction circuit to the second DC electrical power and providing the second DC electrical power to the first battery without providing the second DC electrical power to the second primary side.

The combined first and second battery charging mode may include converting the first DC electrical power from the power factor correction circuit to the second DC electrical power and providing the second DC electrical power to both of the first battery and the second primary side.

The first battery to second battery charging mode may include providing the second DC electrical power from the first battery to the second primary side, converting the second DC electrical power to the third DC electrical power, and providing the third DC electrical power to the second battery.

The power factor correction circuit may be configured to convert a single-phase AC electrical power input to the first DC electrical power while operating according to a single-phase input mode and/or to convert a three-phase AC electrical power input to the first DC electrical power while operating according to a three-phase input mode.

The integrated power converter may include a housing configured to enclose the power factor correction circuit and the first, second, and third circuits.

The first battery may be a rechargeable high voltage battery configured to provide at least 200 volts of DC electrical potential. The second battery may be a rechargeable low voltage battery configured to provide no more than 60 or 200 volts of DC electrical potential.

One non-limiting aspect of the present disclosure relates to an integrated power converter. The integrated power converter may include an AC-DC power factor correction circuit configured to convert a single-phase AC electrical power input to a first DC electrical power while operating according to a single-phase input mode and to convert a three-phase AC electrical power input to the first DC electrical power while operating according to a three-phase input mode. The integrated power converter may additionally include a DC-DC converter circuit having a first circuit with a plurality of first transistors configured to interface the first DC electrical power with a first primary side of a first transformer, a second circuit with a plurality of second transistors arranged in an integrated formation and configured to interface a second DC electrical power at a first secondary side of the first transformer with a first battery and with a second primary side of a second transformer, and a third circuit with a plurality of third transistors configured to interface a third DC electrical power at a second secondary side of the of the second transformer with a second battery. The integrated power converter may yet further include a controller configured to control the AC-DC power factor correction circuit to operate in the single-phase input mode in response to a first command received via a control signal, control the AC-DC power factor correction circuit to operate in the three-phase input mode in response to a second command received via the control signal, control the second transistors to provide the second DC electrical power to the first battery without providing the second DC electrical power to the second primary side while operating according to a first battery charging mode, control the second transistors to provide the second DC electrical power to both of the first battery and the second primary side while operating according to a combined first and second battery charging mode, and control the second transistors to provide the second DC electrical power from the first battery to the second primary side while operating according to a first battery to second battery charging mode.

The first transistors may be comprised of no more than four transistors, and the third transistors are comprised of no more than two transistors.

The integrated power converter may include a housing configured to enclose the first, second, and third circuits.

One non-limiting aspect of the present disclosure relates to an integrated power converter. The integrated power converter may include an AC-DC power factor correction circuit configured to convert a single-phase and a three-phase AC electrical power input to a first DC electrical power. The integrated power converter may additionally include a DC-DC converter circuit having a first circuit with no more than four transistors configured to interface the first DC electrical power with a first primary side of a first transformer, a second circuit with no more than six transistors arranged in an integrated formation and configured to interface a second DC electrical power at a first secondary side of the first transformer with a first battery and with a second primary side of a second transformer, and a third circuit with no more than two transistors configured to interface a third DC electrical power at a second secondary side of the of the second transformer with a second battery. One non-limiting aspect of the present disclosure relates to an integrated power converter. The integrated power converter may yet further include a controller configured to control the second circuit to provide the second DC electrical power to the first battery without providing the second DC electrical power to the second primary side while operating according to a first battery charging mode, control the second circuit to provide the second DC electrical power to both of the first battery and the second primary side while operating according to a combined first and second battery charging mode, and control the second circuit to provide the second DC electrical power from the first battery to the second primary side while operating according to a first battery to second battery charging mode.

The above features and advantages along with other features and advantages of the present teachings are readily apparent from the following detailed description of the modes for carrying out the present teachings when taken in connection with the accompanying drawings. It should be understood that even though the following Figures and embodiments may be separately described, single features thereof may be combined to additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates a schematic diagram of a vehicle having an onboard charger in accordance with one non-limiting aspect of the present disclosure.

FIG. 2 illustrates a schematic diagram of the onboard charger in accordance with one non-limiting aspect of the present disclosure.

FIG. 3 illustrates a schematic diagram of an integrated power stage converter circuit in accordance with one non-limiting aspect of the present disclosure.

FIG. 4 illustrates a schematic diagram of a third circuit in accordance with one non-limiting aspect of the present disclosure.

FIG. 5 illustrates a schematic diagram of the integrated power stage converter circuit operating according to a first mode of a first battery charging mode in accordance with on non-limiting aspect of the present disclosure.

FIG. 6 illustrates a schematic diagram of the integrated power stage converter circuit operating according to a second mode of the first battery charging mode in accordance with on non-limiting aspect of the present disclosure.

FIG. 7 illustrates a schematic diagram of the integrated power stage converter circuit operating according to a first mode of a combined first and second battery charging mode in accordance with on non-limiting aspect of the present disclosure.

FIG. 8 illustrates a schematic diagram of the integrated power stage converter circuit operating according to a second mode of the combined first and second battery charging mode in accordance with on non-limiting aspect of the present disclosure.

FIG. 9 illustrates a schematic diagram of the integrated power stage converter circuit operating according to a first mode of a HV battery to LV battery charging mode in accordance with on non-limiting aspect of the present disclosure.

FIG. 10 illustrates a schematic diagram of the integrated power stage converter circuit operating according to a second mode of the HV battery to LV battery charging mode in accordance with on non-limiting aspect of the present disclosure.

FIG. 11 illustrates a flowchart of a method for battery charging in accordance with one non-limiting aspect of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

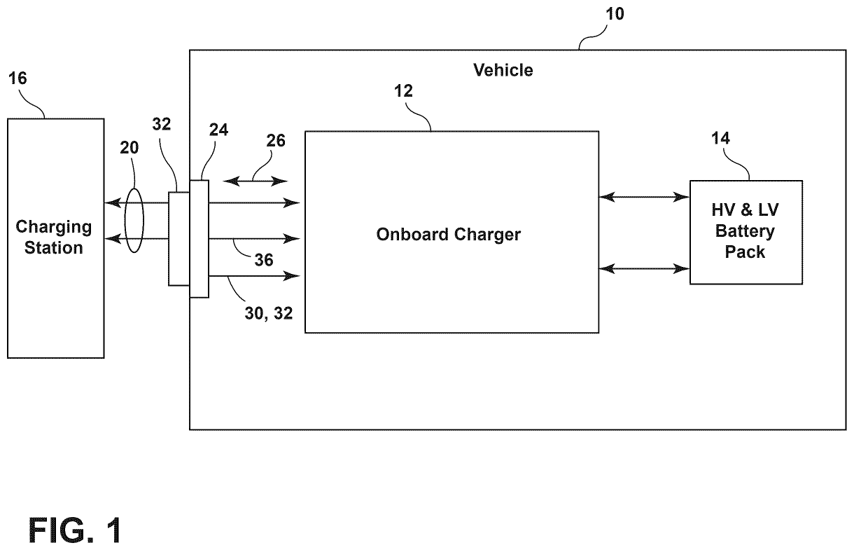

FIG. 1 illustrates a schematic diagram of a vehicle 100 having an onboard charger 12 in accordance with one non-limiting aspect of the present disclosure. The charger 12 may be configured in the manner described herein to facilitate charging a battery pack 14 with electrical power provided from a charging station 16 offboard the vehicle 10, such as an alternating current (AC) charging station 16. The charging station 16 may include a charging cable 20 and a charging plug 22 to facilitate exchanging electrical power and control signaling with the charger 12 via a charging socket 24 included on the vehicle 10. Electrical power 26 may flow between the charging station 16 and the charger 12 in either direction via the charging cable 20, the charging plug 22, and the charging socket 24. The electrical power 26 may be single-phase and/or three-phase alternating-current (AC) electrical power, depending on the configuration of the charging station 16. A control signal 30 may be used to convey multiple commands 32 to the charger 12, which may optionally instruct the charger 12 as to a number of phases in the electrical power 26 and a direction that the electrical power 26 is flowing (e.g., into the charger 12 via the charging socket 24 or out of the charging socket 24 from the charger 12.

A communication signal 36 may be exchanged between the charging station 16 and the charger 12 to provide signaling information between the charging station 16 and the charger 12 to start, control, and stop the flow of the electrical power 26. The charging station 16 may be operational to provide electrical power (e.g., electrical current at a voltage) to the vehicle 10 to recharge the battery pack. In various embodiments, the charging stations 16 may be compliant with the SAE International J1716 standard and/or the International Electrotechnical Commission (IEC) 61851-1 standard, optionally a Level 1 AC or a Level 2 AC charger 12. The present disclosure, however, fully contemplates supporting other charging standards to meet the design criteria of a particular application, optionally with the charger 12 being configured to facilitate charging and discharging the battery pack 14. The vehicle 10 may be an electric-powered vehicle, a hybrid vehicle, or a plug-in hybrid vehicle. The vehicle 10 may include, but is not limited to, a passenger vehicle, a truck, an autonomous vehicle, a motorcycle, a boat, and/or an aircraft. In some embodiments, the vehicle 10 may be a stationary object such as a room, a booth and/or a structure.

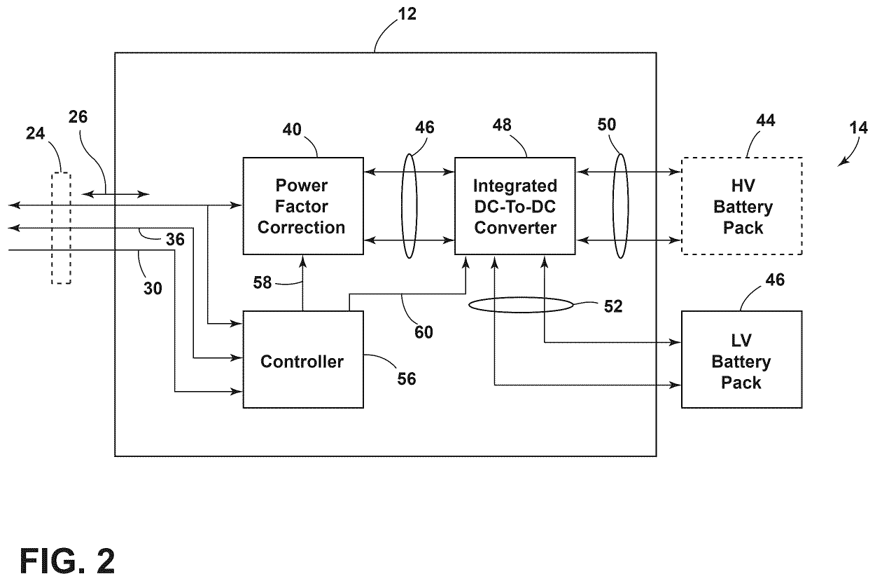

FIG. 2 illustrates a schematic diagram of the onboard charger 12 in accordance with one non-limiting aspect of the present disclosure. As shown, the charger 12 may include an AC-DC power factor correction circuit 40 configured to implement a bridgeless totem pole power factor correction circuit or other suitable circuit having capabilities for providing AC-DC and DC-AC conversions. The battery pack 14 may be a rechargeable energy storage system configured to store electrical energy. The battery pack 14 may be generally operational to receive electrical power from the charger 12 and provide electrical power to the charger 12. The battery pack 14 may include multiple battery modules electrically connected in series and/or in parallel, which are shown for exemplary purposes to include independent high voltage (HV) battery 44, e.g., 200-1000 VDC, and a low voltage (LV) battery 46, e.g., 6-60 VDC or at least less than 200 VDC.

The HV battery 44, for example, may be operational at or above 200 VDC to provide electrical power to a traction motor (not shown) used to drive the vehicle 10, and the LV battery 46 may be operational below 60 VDC to provide electrical power to vehicle systems (not shown) operating at a lower voltage than the traction motor. While operating in a single-phase input mode or a three-phase mode, the power factor correction circuit 40 may be configured to respectively convert an input single-phase electrical power or an input three-phase electrical power to a first direct-current (DC) electrical power 46. An integrated power stage DC-DC converter circuit 48 may be configured to convert the first DC electrical power 46 to a second DC electrical power 50 suitable for charging the HV battery 44 and to a third DC electrical power 52 suitable for charging the LV battery 46.

The charger 12 may include a controller 56 configured to process the control signal 30, the commands 32, and/or the communication signal 36, such as to determine whether to charge one or both of the HV and LV batteries 44, 48 according to the charging station 16 providing single-phase or three-phase AC input electrical power and/or to determine whether the HV battery 44 is to discharge or otherwise provide the second DC electrical power 50 to the charging station 12 or another device or vehicle connected the power factor correction circuit 40. The controller 56 may be configured to correspondingly generate a switching signal 58 for providing switching information to controls the power factor correction circuit 40 and a conversion signal 60 to control the integrated converter circuit 48. The controller 56 may include one or more processors configured to facilitate the operations, processes, functions, etc. described herein, optionally according to the processors executing according to non-transitory instructions or software stored on an associated computer readable storage medium. The software, when executed, may cause the processors to generate the switching signal 58, the DC conversion signal 60, and/or additional signals and commands attendant to facilitating the battery charging and discharging contemplated herein.

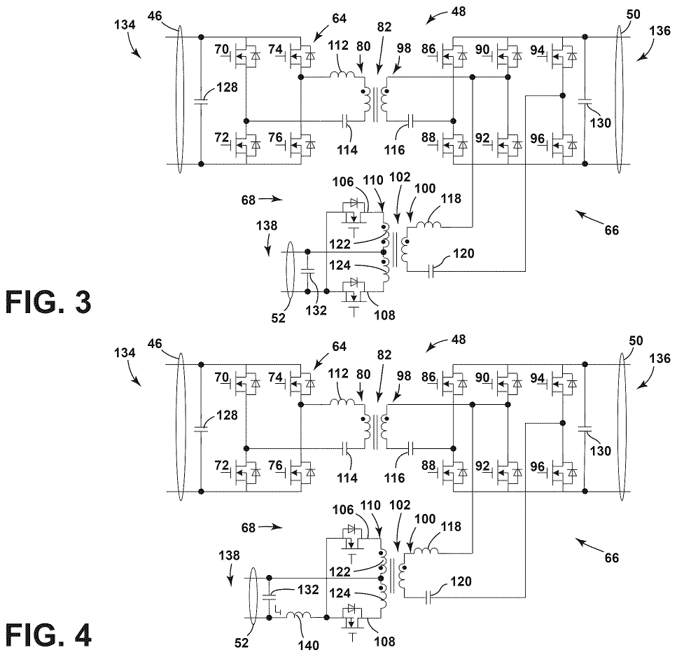

FIG. 3 illustrates a schematic diagram of the integrated converter circuit 48 in accordance with one non-limiting aspect of the present disclosure. The integrated converter circuit 48 may be comprised of a plurality of circuit components, which may be configured in the illustrated manner to provide a first circuit 64, a second circuit 66, and a third circuit 68. The first circuit 64 may include a plurality of first transistors 70, 72, 74, 76 configured to interface the first DC electrical power 46 of power factor correction circuit 40 with a first primary side 80 of a first transformer 82. The second circuit 66 may include a plurality of second transistors 86, 88, 90, 92, 94, 96 arranged in an integrated formation and configured to interface the second DC electrical power 50 at a first secondary side 98 of the first transformer 82 with the HV (first) battery 44 and with a second primary side 100 of a second transformer 102. The third circuit 68 may include a plurality of third transistors 106, 108 configured to interface the third DC electrical power 52 at a second secondary side 110 of the of the second transformer 102 with the LV (second) battery 46.

The first transformer 82 may include a first inductor 112, a first capacitor 114, and a second capacitor 116 to provide an LCC or CLLC topology. The illustrated LCC topology is presented for non-limiting purposes as the present disclosure fully contemplates other configurations for the first transformer 82, including but not limited to CLLC and/or LLC typologies. The second transformer 102 may include a second inductor 118 and a third capacitor 120, optionally with the second secondary side 110 having a split configuration comprising an upper winding 122 and a lower winding 124, which may provide an LLC or CLLC topology. Additional fourth, fifth, and sixth capacitors 120, 130, 132 may be included at an interface 134 to the power factor correction circuit 40, an interface 136 with the HV battery 44, and an interface 138 with the LV battery 46 to facilitate smooth and otherwise manipulating the DC electrical power passing thereby. FIG. 4 illustrates a schematic diagram of the third circuit 68 optionally including a third inductor 140 operable with the sixth capacitor 132 facilitate smoothing the third DC electrical power 52.

The first transistors 70, 72, 74, 76 may be comprised of four transistors, with pairs of the four transistors 70, 72, 74, 76 being connected source to drain in the illustrated manner with each pair thereof being connected in parallel. The second transistors 86, 88, 90, 92, 94, 96 may be comprised of six transistors, optionally with no more than six transistors, with the integrated formation thereof corresponding with pairs of the six transistors 86, 88, 90, 92, 94, 96 being connected source to drain in the illustrated manner with each pair thereof being connected in parallel. The third transistors 106, 108 may be comprised of two transistors connected source to drain. The transistors 70, 72, 74, 76, 86, 88, 90, 92, 94, 96, 106, 108 are shown in the illustrated configuration for exemplary and non-limiting purposes as the present disclosure fully contemplates including more or less transition transistors, or other types of switches or controllers, optionally with the transistors 70, 72, 74, 76, 86, 88, 90, 92, 94, 96, 106, 108 being deployed in other arrangements and formations. The illustrated integrated formation of the six transistors 86, 88, 90, 92, 94, 96 comprising the second circuit 66 is believed to be particularly beneficial in integrating the first transformer 82 with the second transformer 102, optionally with the associated circuit componentry, i.e., the illustrated circuit components comprising the first, second, and third circuits 64, 66, 68, being enclosed or otherwise disposed within a common, singular housing or module.

The integrated formation of the second transistors 86, 88, 90, 92, 94, 96 may be considered as a power stage integration of circuitry used to charge the high and low voltage batteries 44, 46. The power station integration may include arranging circuit components in an integrated or shared formation whereby a portion of the circuit components may be employed to charge both of the high and low voltage battery packs, as opposed to being dedicated to charging no more than one of the high and low voltage battery packs. These integrated or shared circuit components may reduce or otherwise limit the quantity of circuit components included as part of the onboard charger 12, which may in turn be beneficial in limiting vehicle weight, complexity, costs, etc. By way of example, instead of the second circuit 66 including four transistors interacting with the first secondary side 98 and another four transistors interacting with the second primary side 100, the integrated formation of the second transistors 86, 88, 90, 92, 94, 96 may be used to effectively eliminate two transistors, with the illustrated six, second transistors 86, 88, 90, 92, 94, 96 providing equivalent functionality. The integrated formation may also be beneficial in eliminating the need for the vehicle 10 to include a separate or standalone module for charging the LV battery 46.

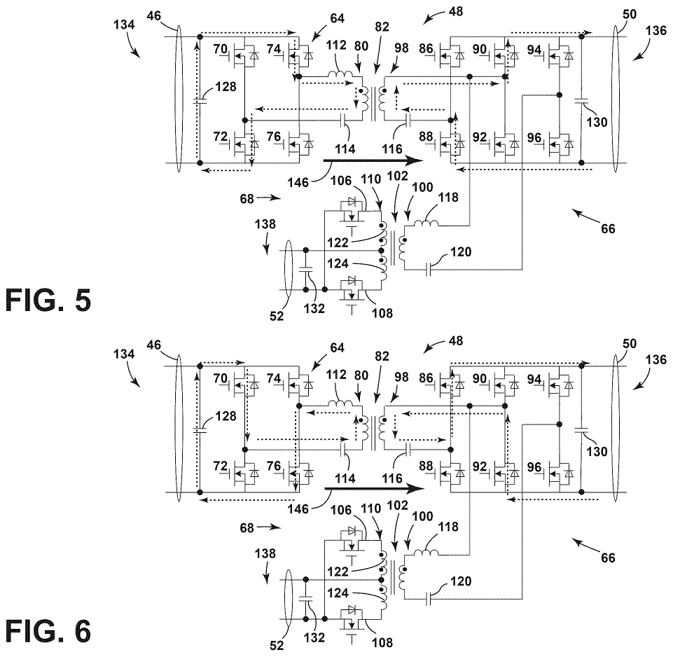

FIG. 5 illustrates a schematic diagram of the integrated converter circuit 48 operating according to a first mode of a first battery charging mode in accordance with on non-limiting aspect of the present disclosure. FIG. 6 illustrates a schematic diagram of the integrated converter circuit 48 operating according to a second mode of the first battery charging mode in accordance with one non-limiting aspect of the present disclosure. The first battery charging mode may correspond with the controller 56 generating the DC conversion signal 60 to facilitate charging of the HV battery 44, with the first mode optionally corresponding with an active phase and the second mode corresponding with a symmetry active phase and/or the first and second modes each corresponding with a half cycle or other modulation associated with charging and discharging circuit components of the integrated converter circuit 48. As shown, a power flow 146 illustrates the charging generally corresponding with converting the first DC electrical power 46 to the second DC electrical power 50 to charge the HV battery 44, with the illustrated arrows indicating electrical transfer associated with the first and second modes.

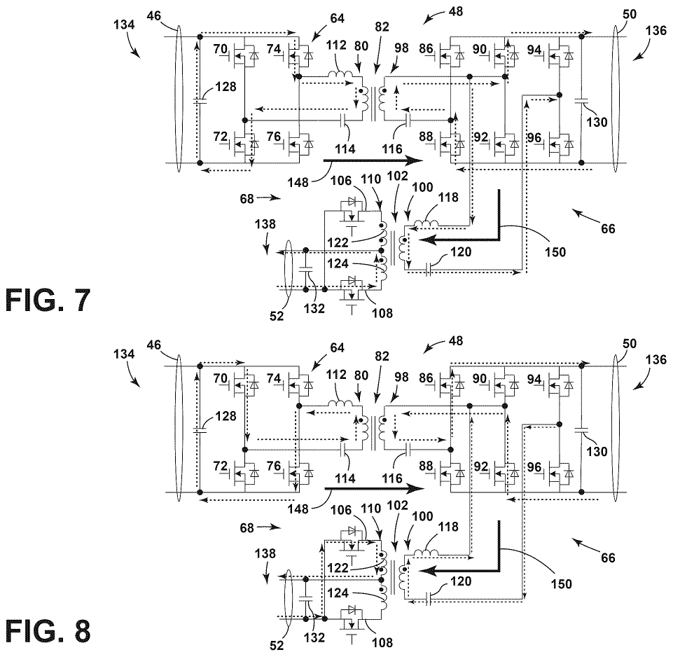

FIG. 7 illustrates a schematic diagram of the integrated converter circuit 48 operating according to a first mode of a combined first and second battery charging mode in accordance with on non-limiting aspect of the present disclosure. FIG. 8 illustrates a schematic diagram of the integrated converter circuit 48 operating according to a second mode of the combined first and second battery charging mode in accordance with on non-limiting aspect of the present disclosure. The combined first and second battery charging mode may correspond with the controller 56 generating the DC conversion signal 60 to facilitate concurrently charging both of the HV and LV batteries 44, 46, with the first mode optionally corresponding with an active phase and the second mode corresponding with a symmetry active phase and/or the first and second modes each corresponding with a half cycle or other modulation associated with charging and discharging circuit components of the integrated converter circuit 48. As shown, multiple power flows 148, 150 illustrate the charging generally corresponding with converting the first DC electrical power 46 to the second and third DC electrical powers 50, 52 to charge the HV and LV batteries 44, 46, with the illustrated arrows indicating electrical transfer associated with the first and second modes.

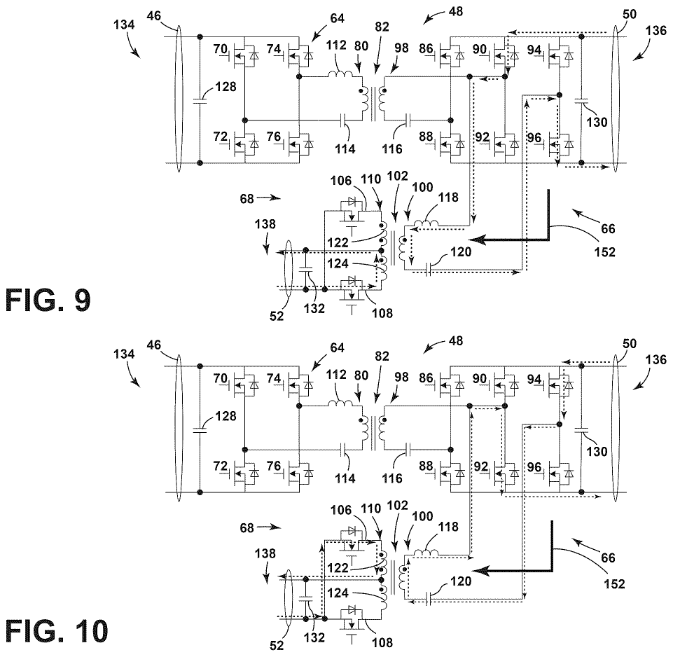

FIG. 9 illustrates a schematic diagram of the integrated converter circuit 48 operating according to a first mode of a HV battery to LV battery charging mode in accordance with on non-limiting aspect of the present disclosure. FIG. 10 illustrates a schematic diagram of the integrated converter circuit 48 operating according to a second mode of the HV battery to LV battery charging mode in accordance with on non-limiting aspect of the present disclosure. The HV battery to LV battery charging mode may correspond with the controller 56 generating the DC conversion signal 60 to facilitate charging the LV battery 46 with electrical power from the HV battery 44, or more specifically, with the HV battery 44 providing the second DC electrical power 50 to charge the LV battery 46. The first mode may optionally correspond with an active phase and the second mode corresponding with a symmetry active phase and/or the first and second modes each corresponding with a half cycle or other modulation associated with charging and discharging circuit components of the integrated converter circuit 48. As shown, a power flow 152 illustrates the HV battery 44 providing the second DC electrical power 50 to the second primary side 100 for use in charging the LV battery 46, with the illustrated arrows indicating electrical transfer associated with the first and second modes.

The following table illustrates an exemplary configuration of the controller individually activating, e.g., turning on, and deactivating, e.g., turning off, the first, second, and third transistors 70, 72, 74, 76, 86, 88, 90, 92, 94, 96, 106, 108 depending on when the controller is operating according to the first battery charging mode (AC->HV DC Battery), the combined first and second battery charging mode (AC->HV & LV DC Batteries), and a first battery to second battery charging mode (HV Battery->LV DC Battery).

| | | AC->HV DC Battery | | AC->HV & LV DC Batteries | | HV Battery -> LV DC Battery | |
|---|---|---|---|---|---|---|---|
| Circuit | Q | Mode 1 | Mode 2 | Mode 1 | Mode 2 | Mode 1 | Mode 2 |
| 1 | 70 | Off | On | Off | On | Off | Off |
| | 72 | On | Off | On | Off | Off | Off |
| | 74 | On | Off | On | Off | Off | Off |
| | 76 | Off | On | Off | On | Off | Off |
| 2 | 86 | Off | On | Off | On | Off | Off |
| | 88 | On | Off | On | Off | Off | Off |
| | 90 | On | Off | On | Off | On | Off |
| | 92 | Off | On | Off | On | Off | On |
| | 94 | Off | Off | Off | On | Off | On |
| | 96 | Off | Off | On | Off | On | Off |
| 3 | 106 | Off | Off | Off | On | Off | On |
| | 108 | Off | Off | On | Off | On | Off |

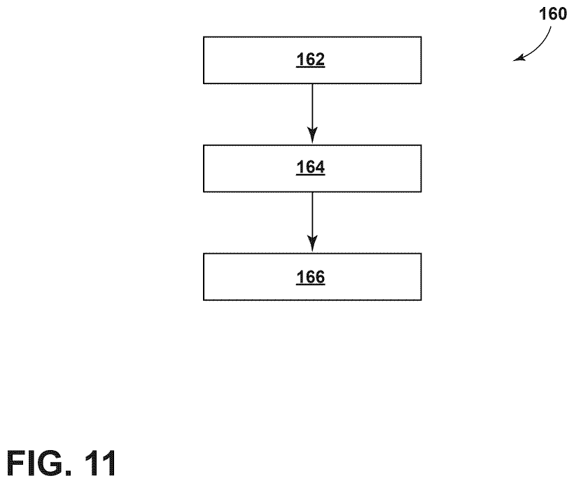

FIG. 11 illustrates a flowchart 160 of a method for battery charging in accordance with one non-limiting aspect of the present disclosure. Block 162 relates to selecting one of a first battery charging mode, a combined first and second battery charging mode, and a first battery to second battery charging mode. Block 164 relates to generating the conversion signal 142 for controlling the integrated power stage converter to implement the mode selected in Block 162. Block 166 relates to implementing the charging according to the conversion signal 142. The method is predominately described with respect to facilitating charging of one or both the HV and LV batteries 44, 46 for exemplary purposes as the present disclosure fully contemplates, as support above, discharging electrical power from one or both of the HV and LV batteries 44, 46 using a similar control methodology.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An integrated power converter, comprising:
a first circuit including a plurality of first transistors configured to interface a first DC electrical power of power factor correction circuit with a first primary side of a first transformer;
a second circuit including a plurality of second transistors arranged in an integrated formation and configured to interface a second DC electrical power at a first secondary side of the first transformer with a first battery and with a second primary side of a second transformer; and
a third circuit including a plurality of third transistors configured to interface a third DC electrical power at a second secondary side of the of the second transformer with a second battery.

2. The integrated power converter according to claim 1, wherein:
the second transistors are comprised of no more than six transistors.

3. The integrated power converter according to claim 1, wherein:
the second transistors are comprised of six transistors, with the integrated formation corresponding with pairs of the six transistors connected source to drain and each pair thereof connected in parallel.

4. The integrated power converter according to claim 3, wherein:
the first transistors are comprised of four transistors, with pairs of the four transistors connected source to drain and each pair thereof connected in parallel.

5. The integrated power converter according to claim 3, wherein:
the third transistors are comprised of two transistors connected source to drain.

6. The integrated power converter according to claim 5, wherein:
the third circuit includes a capacitor configured to smooth the third DC electrical power.

7. The integrated power converter according to claim 5, wherein:
the third circuit includes a capacitor and an inductor configured to smooth the third DC electrical power.

8. The integrated power converter according to claim 3, further comprising:
a controller configured to selectively control the first, second, and third transistors to implement a first battery charging mode, a combined first and second battery charging mode, and a first battery to second battery charging mode.

9. The integrated power converter according to claim 8 wherein:
the first battery charging mode includes converting the first DC electrical power from the power factor correction circuit to the second DC electrical power and providing the second DC electrical power to the first battery without providing the second DC electrical power to the second primary side.

10. The integrated power converter according to claim 8, wherein:
the combined first and second battery charging mode includes converting the first DC electrical power from the power factor correction circuit to the second DC electrical power and providing the second DC electrical power to both of the first battery and the second primary side.

11. The integrated power converter according to claim 8, wherein:
the first battery to second battery charging mode includes providing the second DC electrical power from the first battery to the second primary side, converting the second DC electrical power to the third DC electrical power, and providing the third DC electrical power to the second battery.

12. The integrated power converter according to claim 8, wherein:
the power factor correction circuit is configured to convert a single-phase AC electrical power input to the first DC electrical power while operating according to a single-phase input mode.

13. The integrated power converter according to claim 8, wherein:
the power factor correction circuit is configured to convert a three-phase AC electrical power input to the first DC electrical power while operating according to a three-phase input mode.

14. The integrated power converter according to claim 8, wherein:
the power factor correction circuit is configured to convert a single-phase AC electrical power input to the first DC electrical power while operating according to a single-phase input mode; and
the power factor correction circuit is configured to convert a three-phase AC electrical power input to the first DC electrical power while operating according to a three-phase input mode.

15. The integrated power converter according to claim 14, further comprising:
a housing configured to enclose the power factor correction circuit and the first, second, and third circuits.

16. The integrated power converter according to claim 8, wherein:
the first battery is a rechargeable high voltage battery configured to provide at least 200 volts of DC electrical potential; and
the second battery is a rechargeable low voltage battery configured to provide no more than 200 volts of DC electrical potential.

17. An integrated power converter, comprising:
an AC-DC power factor correction circuit configured to:
convert a single-phase AC electrical power input to a first DC electrical power while operating according to a single-phase input mode; and
convert a three-phase AC electrical power input to the first DC electrical power while operating according to a three-phase input mode;
a DC-DC converter circuit including:
a first circuit having a plurality of first transistors configured to interface the first DC electrical power with a first primary side of a first transformer;
a second circuit having a plurality of second transistors arranged in an integrated formation and configured to interface a second DC electrical power at a first secondary side of the first transformer with a first battery and with a second primary side of a second transformer; and
a third circuit having a plurality of third transistors configured to interface a third DC electrical power at a second secondary side of the of the second transformer with a second battery; and
a controller configured to:
control the AC-DC power factor correction circuit to operate in the single-phase input mode in response to a first command received via a control signal;
control the AC-DC power factor correction circuit to operate in the three-phase input mode in response to a second command received via the control signal;
control the second transistors to provide the second DC electrical power to the first battery without providing the second DC electrical power to the second primary side while operating according to a first battery charging mode;
control the second transistors to provide the second DC electrical power to both of the first battery and the second primary side while operating according to a combined first and second battery charging mode; and
control the second transistors to provide the second DC electrical power from the first battery to the second primary side while operating according to a first battery to second battery charging mode.

18. The integrated power converter according to claim 17, wherein:
the first transistors are comprised of no more than four transistors;
the second transistors are comprised of no more than six transistors; and
the third transistors are comprised of no more than two transistors.

19. The integrated power converter according to claim 18, further comprising:
a housing configured to enclose the first, second, and third circuits.

20. An integrated power converter, comprising:
an AC-DC power factor correction circuit configured to convert a single-phase and a three-phase AC electrical power input to a first DC electrical power;
a DC-DC converter circuit including:
a first circuit having no more than four transistors configured to interface the first DC electrical power with a first primary side of a first transformer;
a second circuit having no more than six transistors arranged in an integrated formation and configured to interface a second DC electrical power at a first secondary side of the first transformer with a first battery and with a second primary side of a second transformer; and
a third circuit having no more than two transistors configured to interface a third DC electrical power at a second secondary side of the of the second transformer with a second battery; and
a controller configured to:
control the second circuit to provide the second DC electrical power to the first battery without providing the second DC electrical power to the second primary side while operating according to a first battery charging mode;
control the second circuit to provide the second DC electrical power to both of the first battery and the second primary side while operating according to a combined first and second battery charging mode; and
control the second circuit to provide the second DC electrical power from the first battery to the second primary side while operating according to a first battery to second battery charging mode.
